(19) United States
(12) Patent Application Publication
(10) Pub. No.: US 2008/0199243 A1
(43) Pub. Date: Aug. 21, 2008

(54) BALLPOINT PEN TIP

(75) Inventors: Myeong-Ki KIM, Daejeon-city (KR); Hak Jae KIM, Seoul (KR)

Correspondence Address: HARRITY SNYDER, LLP, 11350 Random Hills Road, SUITE 600, FAIRFAX, VA, 22030, US

(73) Assignee: DONG-A PENCIL CO., LTD., Seoul (KR)

(21) Appl. No.: 11/753,110

(22) Filed: May 24, 2007

(30) Foreign Application Priority Data
Feb. 15, 2007 (KR) 10-2007-0015803

(51) Int. Cl. B43K 7/00

(52) U.S. Cl. 401/216

(57) ABSTRACT

In order that pressure is always applied to a center part of a ball and ink flows smoothly, a ballpoint pen tip according to an exemplary embodiment of the invention includes: a ball that has a diameter of 0.7 mm or more; a tip main body that has a ball holder formed at a front end thereof so as to support the ball to be rotatable while a portion of the ball is exposed to the outside; an ink outflow gap provided within the center thereof so as to connect the ball holder and an ink storage area, which is assembled to an end portion of an end opposite to the front end; an elastic member that includes a center elastic portion that has a spiral shape, is formed in the ink outflow gap, and constantly applies force to the ball in a direction where the ball is exposed; a rear contact portion that is integrally formed with the center elastic portion at an end portion opposite to the front end of the tip main body and is supported by a support protrusion protruding toward the inside of the ink outflow gap so as not to be separated; a front contact portion that has one end portion integrally formed with the center elastic portion toward the front end of the tip main body and a linear pressing portion coming into contact with the ball at the other end portion; and a separation preventing protrusion that protrudes along an inner circumference of an end portion of the ink outflow gap toward the ball holder such that an end portion of the pressing portion of the elastic member is in contact with a center part of the ball.

### CROSS-REFERENCE TO RELATED APPLICATION

This application claims priority to and the benefit of Korean Patent Application No. 10-2007-0015803 filed in the Korean Intellectual Property Office on Feb. 15, 2007, the entire contents of which are incorporated herein by reference.

### BACKGROUND OF THE INVENTION

(a) Field of the Invention

The present invention relates to a ballpoint pen tip, and more particularly, to a ballpoint pen tip that allows ink to flow smoothly and pressure to be applied to a center part of a ball while an elastic member does not incline one side.

(b) Description of the Related Art

In general, a writing instrument, such as a ballpoint pen, includes an ink storage area that stores ink therein, a core that has a ball formed at a front end thereof so as to be rotatable while a portion of the bail is exposed to the outside and a tip connected to the ink storage area, and an outer housing that protects the core.

As shown in FIG. 1, a general ballpoint pen tip includes a tip main body 1 that has an ink outflow gap 2 through which ink flows toward a ball 9, and an elastic member 6 that is formed in the ink outflow gap 2 so as to apply force to the ball 9 in a direction in which the ball 9 is exposed.

The elastic member 6 includes an elastic portion 7 that is formed by spirally winding one end portion of a wire rod having a diameter of approximately 0.1 mm, and a pressing portion 8 that is linearly formed by straightening the wire rod from the elastic portion 7.

The tip main body 1 includes the ink outflow gap 2 having an inside diameter that is approximately half of the outside diameter thereof. A ball holder 3 having an inside diameter that is the same as the diameter of the ball 9 is formed at a front end of the tip main body 1.

The pressing portion 8 of the elastic member 6 that has a linear shape is provided in the ink outflow gap 2 and applies pressure to a center part of the ball 9,

In the above-described general ballpoint pen tip, when the ball 9 having a diameter of 0.7 mm or more is used, the tip main body 1 having an outside diameter of approximately 2.3 mm or more is used, and the same elastic member 6 as that used for the ball 9 having a diameter of 0.5 mm is used.

As described above, when the elastic member 6 used for the ball 9 having the diameter of 0.5 mm is also used for the ball 9 having the diameter of 0.7 mm or more, a large gap occurs between the inside diameter of the tip main body 1 and the pressing portion 8 of the elastic member 6. Therefore, as shown in FIG. 1, when the ball 9 rotates during the action of writing, movement occurs in the pressing portion 8 of the elastic member 6, and the pressing portion 8 is inclined toward one side. Further, when the pressing portion 8 of the elastic member 6 that has a linear shape is inclined, an elastic force of the elastic member 6 continues to be applied. Therefore, the larger the ball 9 is, the more difficult it is for the pressing portion 8 to return to the center part of the ball 9. Further, the pressure is applied to a portion that is inclined toward one side rather than the center part of the ball 9.

For this reason, directivity in the ink is shown in a writing line when writing is performed, and eccentric abrasion occurs to the ball holder 3, which causes ink to be leaked or dried.

In order to solve the problems, as shown in FIG. 2, the applicant of the present invention has proposed Korean Utility Models Registration No. 20-0342412. In Korean Utility Models Registration No. 20-0342412, in order for the elastic member 6 to apply pressure to the center part of the ball 9 even when the ball 9 having a diameter of 0.7 mm or more is used, a center guide portion 4 is formed in the ink outflow gap 2.

The center guide portion 4 protrudes along an inner circumference of an end portion of the ink outflow gap 2 toward the ball holder 3.

As described above, when the center guide portion 4 is formed, the gap between the pressing portion 8 of the elastic member 6 and the inner circumference of the ink outflow gap 2 is reduced. Therefore, the end portion of the pressing portion 8 that is in contact with the ball 9 is prevented from being separated from the center part of the ball 9.

However, as described above, it is very difficult to form an inclined surface along the inner circumference of the ink outflow gap 2 so as to form the center guide portion 4, and because the ink outflow gap 2 is narrowed, the flow of the ink is reduced.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a ballpoint pen tip that allows an elastic member to apply pressure to a center part of a ball at all times and has a separation preventing protrusion in an ink outflow gap so as to prevent separation of the elastic member and allow ink to flow smoothly.

An exemplary embodiment of the present invention provides a ballpoint pen tip that includes: a ball that has a diameter of 0.7 mm or more; a tip main body that has a ball holder formed at a front end thereof so as to support the ball to be rotatable while a portion of the ball is exposed to the outside, and an ink outflow gap provided within the center thereof so as to connect the ball holder and an ink storage area, which is assembled to an end portion of an opposite side to the front end; an elastic member that includes a center elastic portion having a spiral shape, is formed in the ink outflow gap, and constantly applies force to the ball in a direction where the ball is exposed, a rear contact portion that is integrally formed with the center elastic portion at an end portion opposite to the front end of the tip main body and is supported by a support protrusion protruding toward the inside of the ink outflow gap so as not to be separated, and a front contact portion that has one end portion integrally formed with the center elastic portion toward the front end of the tip main body and a linear pressing portion coming into contact with the ball at the other end portion; and a separation preventing protrusion that protrudes along an inner circumference of an end portion of the ink outflow gap toward the ball holder such that an end portion of the pressing portion of the elastic member is in contact with a center part of the ball. The diameter of the front contact portion of the elastic member may be 90% or more of the inside diameter of the end portion of the ink outflow gap toward the ball holder.

The length of the front contact portion of the elastic member may be equal to or larger than twice the diameter of the front contact portion, and may to be equal to or smaller than half of the distance from the separation preventing protrusion to the end of the rear contact portion.

The length of the pressing portion of the elastic member may be smaller than or equal to the diameter of the front contact portion, and may be equal to or larger than the diameter of a wire rod of the elastic member.

The separation preventing protrusion may be formed to maintain an inclination angle of 25 to 40 degrees toward an opposite side to the ball holder of the tip main body.

### BRIEF DESCRIPTION OF THE DRAWINGS

FIG. 1 is a cross-sectional view illustrating a general ballpoint pen tip;

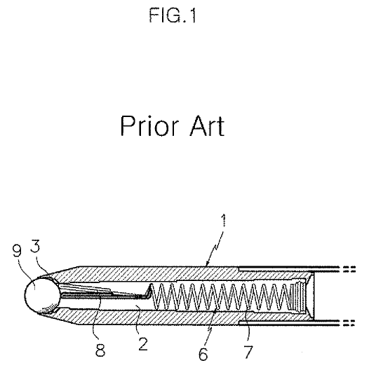

FIG. 2 is a cross-sectional view illustrating the general ballpoint pen tip;

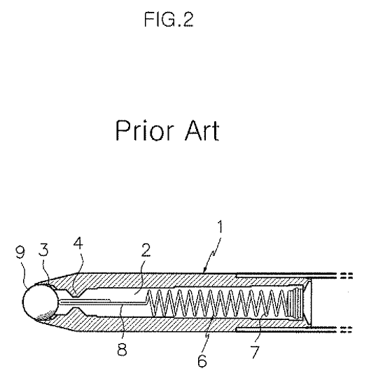

FIG. 3 is a cross-sectional view illustrating a ballpoint pen tip according to an exemplary embodiment of the present invention;

FIG. 4 is a cross-sectional view taken along the line IV-IV of FIG. 3; and

FIG. 5 is an enlarged cross-sectional view illustrating a separation preventing protrusion in the ballpoint pen tip according to the exemplary embodiment of the present invention.

### DETAILED DESCRIPTION OF THE EMBODIMENTS

A ballpoint pen tip according to an exemplary embodiment of the present invention will hereinafter be described in detail with reference to the accompanying drawings.

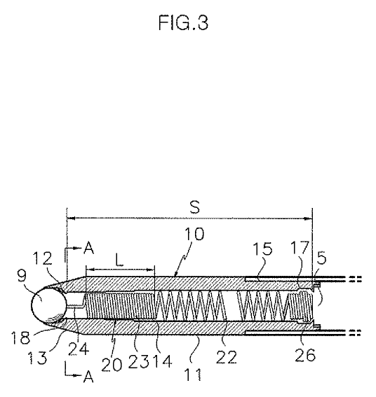

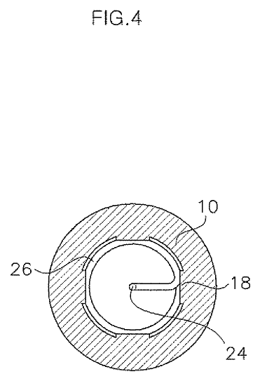

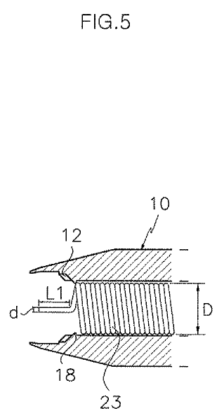

First, as shown in FIGS. 3 to 5, the ballpoint pen tip according to the exemplary embodiment of the present invention includes a ball 9, a tip main body 10, an elastic member 20, and a separation preventing protrusion 18.

The ball 9 has a diameter of 0.7 mm or more.

The tip main body 10 has a ball holder 12 at a front end thereof. The ball 9 is supported by the ball holder 12 so as to be rotatable while a portion of the ball 9 is exposed. Further, an ink outflow gap 14 is formed in the tip main body 10. The ink outflow gap 14 is provided within the center of the tip main body 1050 as to connect the ball holder 12 and an ink storage area 5, which is assembled to an end portion opposite to the front end.

A support protrusion 17 protrudes toward the inside of the ink outflow gap 14 so as to prevent separation of the elastic member 20.

The elastic member 20 is formed in the ink outflow gap 14 of the tip main body 10 so as to constantly apply force to the ball 9 in a direction in which the ball 9 is exposed to the outside.

When the ball 9 comes in contact with a writing surface, the ball starts to rotate and transfers ink, which flows through the ink outflow gap 14 from the ink storage area 5, to the writing surface, such that writing is performed.

It is possible to implement a detailed structure of the ball holder 12 by using the structure of the general ballpoint pen tip. Thus, a detailed description thereof will be omitted.

The tip main body 10 is formed of metal. As shown in FIG. 3, the tip main body 10 includes a linear portion 11 having a cylindrical shape and a tapered portion 13 that extends from one end portion of the linear portion 11 and has a conical shape such that the outside diameter of the tapered portion 13 is gradually narrowed toward the front end.

An insertion portion 15 having a reduced outside diameter may be formed at the other end portion of the linear portion 11 such that the tip main body 10 may be easily inserted to the ink storage area 5.

In the above description, when the tapered portion 13 is formed at the front end of the tip main body 10, the ball 9 comes in contact with the writing surface in a predetermined angle range when writing is performed. Therefore, writing is smoothly performed.

As shown in FIG. 3, the above-described tip main body 10 is preferable in that it is possible to maintain constant strength when the outside diameter is 1.5 to 2.5 times as large as the inside diameter.

Further, the ink outflow gap 14 of the tip main body 10 may be formed at an end portion of the ball holder 12, and have an inside diameter that is 40 to 80% of the diameter of the ball 9.

As shown in FIG. 3, the ink outflow gap 14 may have a uniform inside diameter along a longitudinal direction or an inside diameter that is gradually reduced toward the ball holder 12.

Like the elastic member 20 formed in the generally-used ballpoint pen tip, the elastic member 20 is formed of a wire rod having a diameter of approximately 0.1 mm.

As shown in FIG. 3, the elastic member 20 includes a center elastic portion 22 having a spiral shape, a rear contact portion 26, and a front contact portion 23.

The rear contact portion 26 is integrally formed with the center elastic portion 22 at an end portion of the tip main body 10 opposite to the front end. The rear contact portion 26 is supported by the support protrusion 17 that is formed in the ink outflow gap 14, and is prevented from being separated from the tip main body 10.

A linear pressing portion 24 is formed on the front contact portion 23 and comes in contact with the ball 9. The front contact portion 23 is integrally formed with the center elastic portion 22 toward the front end of the tip main body 10.

In the elastic member 20, the pressing portion 24 may be formed by bending a portion of the pressing portion 24 that comes in contact with the ball 9 at an angle of 180° so as to prevent the occurrence of abrasions on the ball 9 when the ball 9 rotates.

The separation preventing protrusion 18 protrudes along the inner circumference of the end portion of the ink outflow gap 14 toward the ball holder 12 such that the end portion of the pressing portion 24 of the elastic member 20 is in contact with the center part of the ball 9.

In the elastic member 20, each of the front contact portion 23 and the rear contact portion 26 is formed when the spirals of the wire rod come in close contact with each other.

As described above, when the spirals of the wire rod are in close contact with each other, bending resistance is generated, which prevents the pressing portion 24 formed at the end portion of the front contact portion 23 toward the ball holder 12 from being misaligned.

The diameter D of the front contact portion 23 of the elastic member 20 may be 90% or more of the inside diameter of the end portion of the ink outflow gap 14 toward the ball holder 12.

As described, when the front contact portion 23 of the elastic member 20 is formed, a gap between the pressing portion 24 of the elastic member 20 and the inner circumference of the ink outflow gap 14 is reduced. Therefore, the end portion of the pressing portion 24 that is in contact with the ball 9 is prevented from deviating from the center part of the ball 9, and an internal space for the wire rod of the front contact portion 23 is sufficiently secured, such that the ink flows smoothly.

Further, it is preferable that the length of the front contact portion 23 of the elastic member 20 is equal to or larger than twice the diameter D of the front contact portion 23 (L≧2D), and is smaller than or equal to half of a distance S from the separation preventing protrusion 18 to the end of the rear contact portion 26 (L≦S/2).

Preferably, the length L of the front contact portion 23 is set such that the pressing portion 24 of the elastic member 20 is effectively supported.

That is, when the length of the front contact portion 23 is too small, it is not possible to effectively support the pressing portion 24 of the elastic member 20. When the ball 9 rotates, movement occurs in the pressing portion 24 that is in close contact with the ball 9, and the pressing portion 24 is inclined toward one side. At this time, when the length of the front contact portion 23 is too small, the bending resistance is reduced. Therefore, the end portion of the pressing portion 24 that is in contact with the ball 9 deviates from the center part of the ball 9, and the purpose of forming the front contact portion 23 becomes inefficient.

Further, it is preferable that the length of the pressing portion 24 of the elastic member 20 is smaller than or equal to the diameter D of the front contact portion 23 (L1≦D), and is equal to or larger than the diameter d of the wire rod of the elastic member 20 (L1≧d).

That is, even when the ball 9 is separated from the ball holder 12, it is preferable that the length of the pressing portion 24 be set such that the end portion of the pressing portion 24 of the elastic member 20 is not exposed from the tip main body 10.

When the end portion of the pressing portion 24 of the elastic member 20 is exposed outside the tip main body 10, the pressing portion 24 may hurt a user or people around the user, or damage the writing surface.

As described above, if the length of the pressing portion 24 is smaller than or equal to the diameter of the front contact portion 23 (L1≦D), even when the ball 9 is separated from the ball holder 12, the elastic member 20 is caught by the separation preventing protrusion 18. Therefore, the elastic member 20 is prevented from being separated from the tip main body 10 and the pressing portion 24 is prevented from being exposed outside the tip main body 10.

The separation preventing protrusion 18 is formed to maintain an inclination angle to 25 to 40 degrees toward an opposite side to the ball holder 12 of the tip main body 10.

Further, the separation preventing protrusion 18 is formed such that the inside diameter of a portion of the separation preventing protrusion 18 that protrudes the most is set in the range of 10 to 15% of the inner circumference of the ink outflow gap 14.

When the separation preventing protrusion 18 is set within the range, the front contact portion 23 having a diameter that is 90% or more of the inside diameter of the ink outflow gap 14 can be supported without being separated from the ball holder 12.

The separation preventing protrusion 18 may be formed along the entire circumference of the inside diameter of the ink outflow gap 14. However, when the separation preventing protrusion 18 is formed along the entire circumference, the flow of the ink may deteriorate. Therefore, it is preferable that the outer circumferential surface be divided into a predetermined number of regions at predetermined intervals and that two to six separation preventing protrusions 18 be formed.

Further, preferably, the separation preventing protrusion 18 is formed of a material (material having high plasticity) having a low restoring force (self elastic force) since a state in which the separation preventing protrusion 18 is formed is maintained.

According to the ballpoint pen tip of the exemplary embodiment of the present invention, even when a ball having a diameter of 0.7 mm or more is used, the spirals of the wire rod of the front contact portion are in close contact with each other, and the bending resistance is generated. Therefore, the pressing portion is prevented from deviating, such that pressure is always applied to the center part of the ball. Therefore, the directivity in the ink does not occur in the writing line when writing is performed, and a uniform writing line is formed.

Further, according to the ballpoint pen tip of the exemplary embodiment of the present invention, since the separation preventing protrusion is formed inside the ink outflow gap so as to reduce the surface length to a minimum, it is possible to prevent the separation of the elastic member and make ink smoothly flow.

While this invention has been described in connection with what is presently considered to be practical exemplary embodiment of the ballpoint pen tip according to the present invention, it is to be understood that the invention is not limited to the disclosed embodiments, but, on the contrary, is intended to cover various modifications and equivalent arrangements included within the spirit and scope of the appended claims.

What is claimed is:

1. A ballpoint pen tip comprising:
a ball that has a diameter of 0.7 mm or more;
a tip main body that has a ball holder formed at a front end thereof so as to support the ball to be rotatable while a portion of the ball is exposed to the outside, and an ink outflow gap provided within the center thereof so as to connect the ball holder and an ink storage area, which is assembled to an end portion opposite to the front end;
an elastic member that includes a center elastic portion that has a spiral shape, is formed in the ink outflow gap, and constantly applies force to the ball in a direction where the ball is exposed, a rear contact portion that is integrally formed with the center elastic portion at an end portion opposite to the front end of the tip main body and is supported by a support protrusion protruding toward the inside of the ink outflow gap so as to not be separated, and a front contact portion that has one end portion integrally formed with the center elastic portion toward the front end of the tip main body and a linear pressing portion coming into contact with the ball at the other end portion; and
a separation preventing protrusion that protrudes along an inner circumference of an end portion of the ink outflow gap toward the ball holder such that an end portion of the pressing portion of the elastic member is in contact with a center part of the ball.

2. The ballpoint pen tip of claim 1, wherein the ink outflow gap of the tip main body is formed at an end portion of the ball holder and has an inside diameter that is 40 to 80% of the diameter of the ball.

3. The ballpoint pen tip of claim 2, wherein the diameter of the front contact portion of the elastic member is 90% or more of the inside diameter of the end portion of the ink outflow gap toward the ball holder.

4. The ballpoint pen tip of claim 3, wherein the length of the front contact portion of the elastic member is equal to or larger than twice the diameter of the front contact portion, and is equal to or smaller than half of the distance from the separation preventing protrusion to the end of the rear contact portion.

5. The ballpoint pen tip of claim 3, wherein the length of the pressing portion of the elastic member is smaller than or equal to the diameter of the front contact portion, and is equal to or larger than the diameter of a wire rod of the elastic member.

6. The ballpoint pen tip of claim 3, wherein the separation preventing protrusion is formed to maintain an inclination angle of 25 to 40 degrees toward an opposite side to the ball holder of the tip main body.
